(19) United States
(12) Patent Application Publication
(10) Pub. No.: US 2006/0204125 A1
(43) Pub. Date: Sep. 14, 2006

(54) Multi-dimensional keystone correction image projection system and method

(76) Inventors: Jeffrey Matthew Kempf, Dallas, TX (US); Rashmi Vijayaraghavan, Plano, TX (US); Donald B. Doherty, Richardson, TX (US)

Correspondence Address: TEXAS INSTRUMENTS INCORPORATED, P O BOX 655474, M/S 3999, DALLAS, TX, 75265, US

(21) Appl. No.: 11/076,092

(22) Filed: Mar. 9, 2005

(51) Int. Cl. G03B 21/14; G06K 9/40

(52) U.S. Cl. 382/274; 353/69; 353/70

(57) ABSTRACT

A digital circuit, system, and method for keystone correction of a projected image utilize a digital compensation engine to resize a digital image prior to projection. Preferred embodiments of the present invention utilize a compensation engine with a separable architecture in which the two-dimensional image-resizing task is partitioned to use two engines. Horizontal image resizing is performed first, followed by vertical image resizing. Two large polyphase, anti-aliasing, finite impulse response (“FIR”) filters are used to resize the data. A 639-tap filter is used for horizontal resizing, and a 383-tap filter for vertical resizing. Pixels in the corrected image can be positioned with arbitrary accuracy to avoid forming stair-stepped lines in the corrected image. The coefficients for the FIR filters can be stored with 10-bit precision to provide a resized image without loss of visible quality. The compensation engine can be readily configured with an ASIC device or in software.

### CROSS REFERENCE TO RELATED APPLICATIONS

The following related U.S. patents and/or commonly assigned patent applications are hereby incorporated herein by reference:

| Patent or | | | Attorney |
|---|---|---|---|
| Ser. No. | Filing Date | Issue Date | Docket No. |
| | Mar. 9, 2005 | | TI-60026 |
| | Mar. 9, 2005 | | TI-39900 |
| 6,712,475 | Aug. 31, 2001 | Mar. 30, 2004 | |

### TECHNICAL FIELD

The present invention relates generally to a system and method for projected image keystone distortion correction, and more particularly to a projection system and method for multi-dimensional keystone correction.

### BACKGROUND

Projection systems may utilize front projection or rear projection to display video signals, which may represent still, partial motion, or full motion display images. In a digital projection system using a digital micromirror device, spatial light modulators create an image that is projected using optical lenses. The spatial light modulators generally are arranged in an electronically controlled array and may be turned on or off to create an image. The spatial light modulators may be reflective or transmissive. Common spatial light modulators include digital micromirror devices such as the Texas Instruments, Inc. “DMD™”, and liquid crystal display devices.

A rear projection system generally comprises a projection mechanism contained within a housing for projection to the rear of a transmissive screen. Back-projection screens are designed so that the projection mechanism and the viewer are on opposite sides of the screen. The screen has light transmitting properties to direct the transmitted image to the viewer.

A front projection system generally has the projection mechanism on the same side of the display screen as the viewer. An example of a front projection system is a portable front projector and a white, reflective, front-projection screen, which may be used, for example, to display presentations in meeting room settings.

Generally, the relative alignment of the projected image source and the projection surface affect the amount of keystone distortion in the displayed image. In FIG. 1, projection source 100 projects an exemplary image containing a uniform grid of lines on a screen 104, that may be supported by a stand 120. Displayed image 102 appears undistorted when the optical or projection axis of projection source 100 is oriented orthogonally to projection surface 104. When the alignment is orthogonal in the vertical direction, vertical grid lines 106 are displayed parallel to each other. Likewise, when the alignment is orthogonal in the horizontal direction, horizontal grid lines 108 are displayed parallel to each other. When both alignments are orthogonal, the displayed image has the same shape as the projected image.

Generally, keystone distortion results when a projector projects an image along a projection axis that is non-orthogonal to the projection surface or display. For example, as shown in FIG. 2A, when the left side 110 of projection screen 104 is tilted toward projector 100, the displayed image 112 appears larger on the right side 114 of the screen than on the left side of the screen, with the image 112 generally having the shape of a keystone or trapezoid. This example describes the projection screen as being tilted, but alternatively the projector may be misaligned to the projection screen and cause the same effect, or both axes may be misaligned to some absolute reference.

Conversely, when the left side 110 of the projection screen 104 is tilted away from the projector 100, as shown in FIG. 2B, the displayed image 116 appears smaller on the right side 114 of the screen than on the left side 110 of the screen. Similarly, when the top 118 of the projection screen 104 is tilted away from the projector 100, as shown in FIG. 2C, the displayed image 122 appears larger on the top 118 of the screen than on the bottom 119 of the screen. And when the top 118 of the projection screen 104 is tilted toward the projector 100, as shown in FIG. 2D, the displayed image 124 appears smaller at the top 118 of the screen than on the bottom 119 of the screen.

Furthermore, these effects may be combined when projection screen 104 and projector 100 are non-orthogonal in both the vertical and horizontal directions. As shown in FIG. 2E, for example, the top right corner 126 of the projection screen 104 is tilted away from the projector 100, generally causing the image 130 to combine horizontal and vertical trapezoids into an arbitrary quadrilateral which is larger in the top right corner 126 of the screen than in the lower left corner 128 of the screen.

One prior art method for correcting keystone distortion is manual correction, such as by physically moving the projector or re-aligning the projection screen to make the optical axes orthogonal to the screen. However, the system components may not be accessible for adjusting, or there may be a physical limitation on the placement of the components preventing sufficient adjustment to correct the distortion. Another prior art method is to provide adjustable optical elements in the projector that can correct keystone distortion. However, this method may only be able to correct small distortions, and can be cost prohibitive. Other prior art methods for two-dimensional keystone correction of an array generally are computationally intensive and may be cost prohibitive for many applications. Other conventional image resizing engines generally use small filter kernels for resizing and typically employ less sophisticated anti-aliasing techniques such as linear or cubic interpolation that do not sufficiently preserve image quality of the keystone-corrected image.

### SUMMARY OF THE INVENTION

These and other problems are generally solved or circumvented, and technical advantages are generally achieved, by preferred embodiments of the present invention that utilize digital keystone correction to perform a resizing operation on a digital image prior to projection. Embodiments of the present invention perform image keystone correction with an efficient, separable architecture in which the two-dimensional image resizing task is partitioned to use two engines, a horizontal image resizing engine and a vertical image resizing engine. Preferably, the horizontal image resizing engine is operated first, followed by the vertical image resizing engine. Also preferably, two large polyphase, anti-aliasing finite impulse response (“FIR”) filters are used to resize the data. In one preferred embodiment, a 639-tap filter is used for the horizontal resizing engine, and a 383-tap filter is used for the vertical resizing engine. In a preferred embodiment, the coefficients for the filters are stored in an array with 10-bit precision. In a preferred embodiment, the horizontal polyphase filter is configured with at least 23 taps. In a preferred embodiment, the vertical polyphase filter is configured with at least 23 taps. In a further preferred embodiment, at least one resizing engine is configured with an ASIC device. In a preferred embodiment, the vertical image-resizing engine performs efficient write operations to a frame memory using a burst write mode.

Another embodiment of the present invention is a method for performing digital keystone correction to a digital image prior to projection. The method includes partitioning the two-dimensional image-resizing task into two operations utilizing a separable, image keystone correction architecture. Preferably, the method includes performing horizontal image resizing first, followed by performing vertical image resizing. Preferably, the method further includes resizing the data using two large polyphase, anti-aliasing finite impulse response (“FIR”) filters. In one preferred embodiment, the method includes using a 639-tap filter for horizontal resizing, and a 383-tap filter for vertical resizing. In a further preferred embodiment, the method includes storing the coefficients for the filters in an array with 10-bit precision. In a preferred embodiment, the method includes configuring the horizontal polyphase filter with at least 23 taps. In a preferred embodiment, the method includes configuring the vertical polyphase filter with at least 23 taps. In a further preferred embodiment, the method includes configuring at least one resizing engine with an ASIC device. In a preferred embodiment, the method includes writing to a frame memory for image correction using a burst write mode.

In accordance with another preferred embodiment of the present invention, a system for digital keystone correction performs a resizing operation on a digital image prior to projection. The system is configured with a digital display device, a lamp, a power supply, and an image resizing process. Embodiments of the present invention utilize a resizing process in the system to perform image keystone correction with an efficient, separable architecture in which the two-dimensional image-resizing task is partitioned to use two resizing engines. Preferably, a horizontal image-resizing engine is operated first, followed by a vertical image-resizing engine. Also preferably, two large polyphase, anti-aliasing finite impulse response (“FIR”) filters are used in the system to resize the data. In one preferred embodiment, a 639-tap filter is used in the system for horizontal resizing, and a 383-tap filter is used in the system for vertical resizing. In a preferred embodiment, the coefficients for the filters are stored in an array with 10-bit precision. In a preferred embodiment, the horizontal polyphase filter in the system is configured with at least 23 taps. In a preferred embodiment, the vertical polyphase filter in the system is configured with at least 23 taps. In a further preferred embodiment, at least one resizing engine in the system is configured with an ASIC device. In a preferred embodiment, the vertical image-resizing engine writes to a frame memory using a burst write mode.

An advantage of a preferred embodiment of the present invention is that a separable architecture has significantly reduced computational requirements compared to a typical, non-separable architecture. Preferably, only eight multiplies and seven adds are used to filter a pixel component such as a red pixel component in the input data stream. A comparable non-separable solution generally would require fifteen multiplies and fourteen adds for the filtering operation. A preferred embodiment thus provides a logic savings of approximately 47% for this filtering operation.

Another advantage of a preferred embodiment of the present invention is that two large, polyphase FIR filters provide image resizing with minimal or imperceptible loss of image quality and with a noticeably sharper image.

Yet another advantage of a preferred embodiment of the present invention is that large FIR filters enable highly precise resolution changes such as may be required by the removal of a single pixel or even a fraction of a pixel to form a corrected image, i.e., the length of a line or column comprising the keystone-corrected image can be changed by a fraction of a pixel. Hence, changes in resolution from one line or column to the next generally appear smooth and continuous.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is an illustration of a projector aligned orthogonally along two axes to a screen;

FIG. 2A is an illustration of a projector misaligned along the horizontal axis to a screen;

FIG. 2B is an illustration of a projector misaligned along the horizontal axis to a screen;

FIG. 2C is an illustration of a projector misaligned along the vertical axis to a screen;

FIG. 2D is an illustration of a projector misaligned along the vertical axis to a screen;

FIG. 2E is an illustration of a projector misaligned along two axes to a screen;

FIG. 3A is an illustration of keystone correction of an image resulting from a projector misaligned along the horizontal axis to a screen;

FIG. 3B is an illustration of a keystone-corrected image after projection from a projector misaligned along the horizontal axis to a screen;

FIG. 4 is an illustration of the processing flow of a raster-scanned image during keystone correction with an image resizing engine of the present invention;

FIG. 5A is an illustration of an input image on a display device of lines with uniform spacing;

FIG. 5B is an illustration of a resized image on a display device resulting in lines with non-uniform line spacing before projection;

FIG. 6 is an illustration of an exemplary raster-scanned image on a display device;

FIG. 7 is an illustration of an exemplary raster-scanned image on a display device after keystone correction configured with a horizontal resizing engine of the present invention;

FIG. 8 is an illustration of an exemplary raster-scanned image on a display device after keystone correction configured with a vertical resizing engine of the present invention;

FIG. 9 is an illustration of sample rate conversion by a non-integer factor;

FIG. 10 is an illustration of filtering image data with a non-polyphase filter;

FIG. 11 is an illustration of filtering image data with a polyphase filter;

FIG. 12 is an illustration of process flow configured with a horizontal resizing engine of the present invention;

FIG. 13 is an illustration of a preferred computation of an alignment point for a horizontal raster-scanned image line;

FIG. 14 is an illustration of a keystone-corrected image of the Greek letter Φ with a horizontal alignment point set less than zero;

FIG. 15 is an illustration of a keystone-corrected image of the Greek letter Φ with a horizontal alignment point set equal to zero;

FIG. 16 is an illustration of a keystone-corrected image of the Greek letter Φ with a horizontal alignment point set equal to the line midpoint;

FIG. 17 is an illustration of a keystone-corrected image of the Greek letter Φ with a horizontal alignment point set equal to the number of pixels per line;

FIG. 18 is an illustration of a keystone-corrected image of the Greek letter Φ with a horizontal alignment point set greater than the number of pixels per line;

FIG. 19 is an illustration of process flow configured with a vertical resizing engine of the present invention;

FIG. 20 is an illustration of the positioning of corrected input image data in frame memory using the keystone correction process of the present invention;

FIG. 21 is an illustration of a burst write operation for a frame memory in accordance with an aspect of the present invention; and

FIG. 22 is an illustration of a projection system configured for image keystone correction in accordance with an aspect of the present invention.

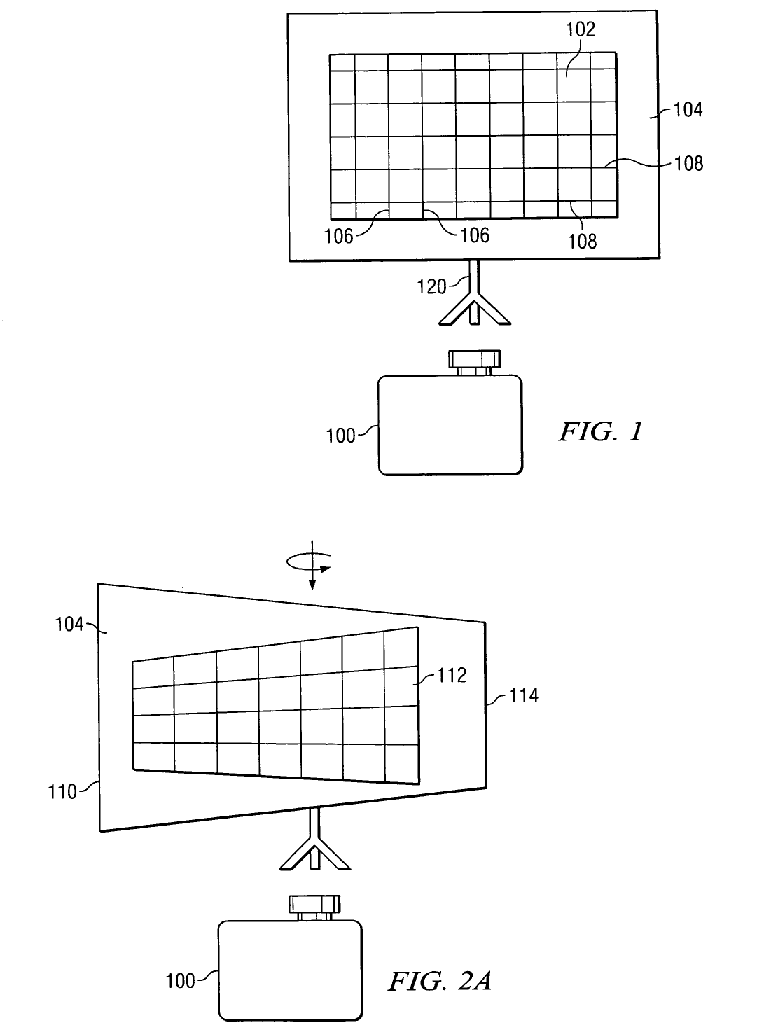

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a digital front- or rear-projection system such as one utilizing spatial light modulators and in particular digital micromirror devices such as DMDs. The invention may also be applied, however, to other microelectromechanical devices, other spatial light modulators such as liquid crystal displays, liquid crystal on silicon devices, grating light valves, and organic light emitting diodes. The invention may also be applied to analog video signals wherein the image is converted to a digital format for processing, or in which a digital image is converted to analog format after processing, or a combination of both.

The present invention will also be described with respect to an “input image” that may be an uncorrected input image, from a camera, film, or other image data source such as an electronic medium including an electronic digital memory device, that may result in keystone or rotational distortion when displayed. The input image is ordinarily coupled to a display device such as a digital micromirror device including DMDs™ or other display devices such as a cathode ray tubes (“CRTs”) or liquid crystal display devices (“LCDs”). As a consequence of axis misalignment, such as an axis misalignment of a projector and a screen, a “distorted image” will be displayed on a screen or other viewable medium. When the input image is corrected by a digital keystone correction process (a digital “resizing engine”) of the present invention, a “resized” image is formed on the display device, and a “corrected” image is displayed on the screen or other viewable medium.

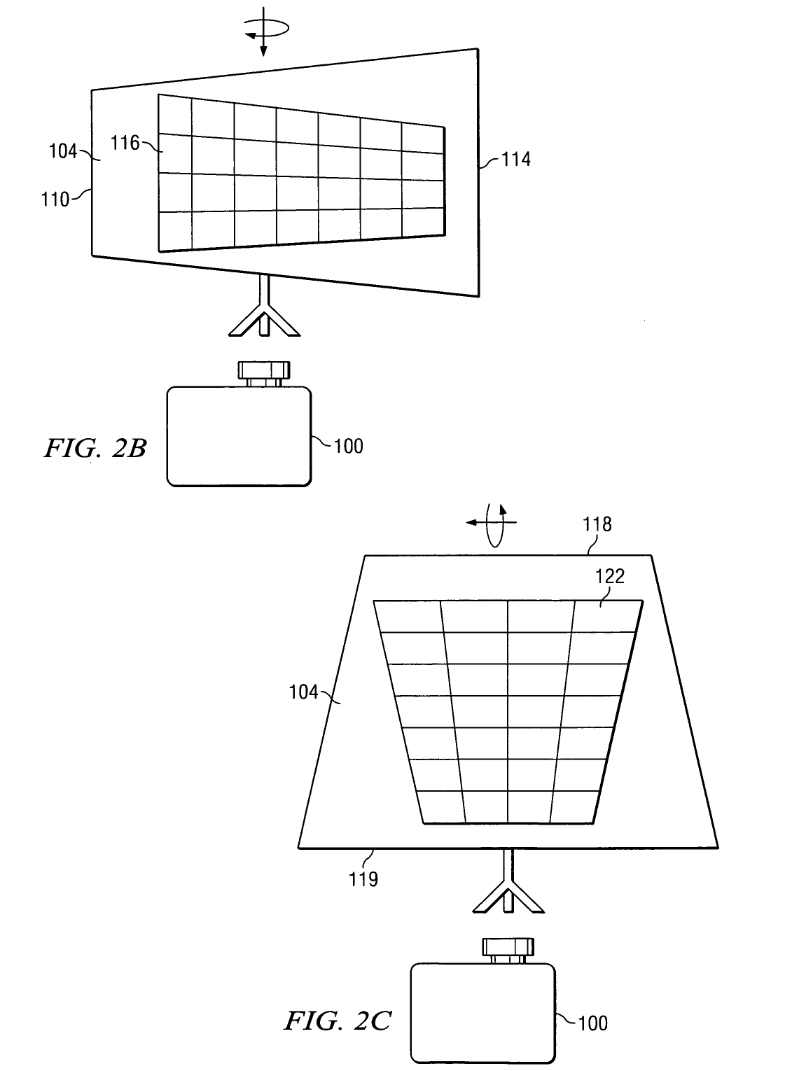

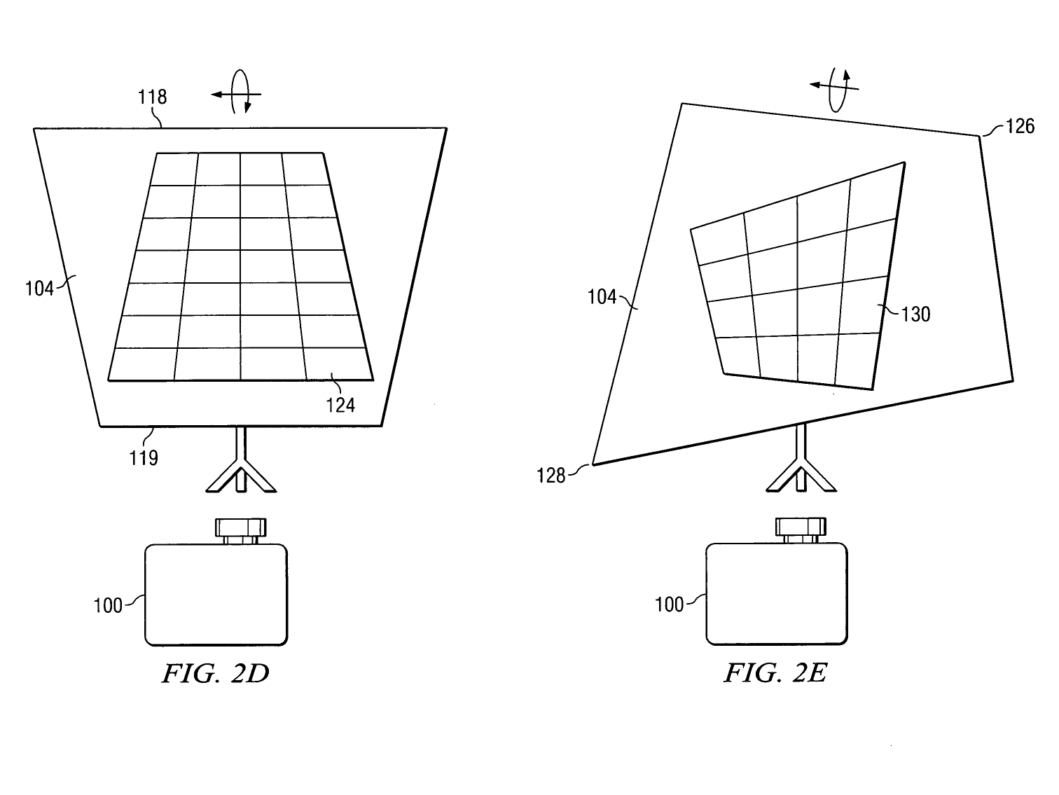

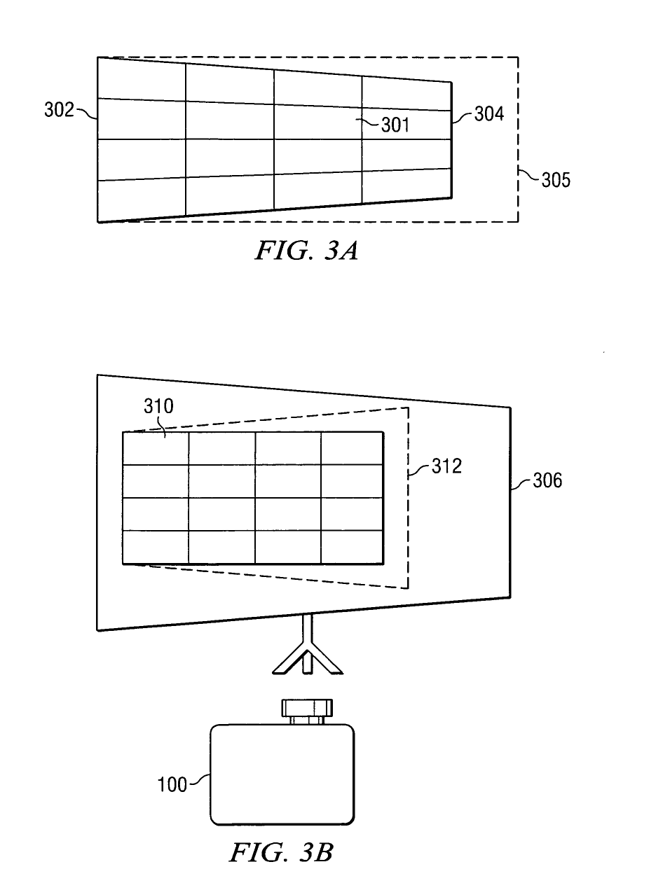

With reference again to FIG. 2A, there is shown an exemplary distorted image 112 resulting from the simple case of projection of a rectangular image on a misaligned screen 104 with only its left edge 110 rotated toward the projector. The two-dimensional digital keystone correction (“resizing”) process of the present invention re-shapes each incoming image before projection so that the final, displayed result appears, as intended, rectangular. The following FIGS. 3A and 3B illustrate this process.

As illustrated on FIG. 3A, a resized image 301 on a display device 305 is decimated (reduced in size by removal of pixels) on a positional basis to form an image which when projected onto a viewable surface such as a screen misaligned with a projector will achieve the desired, visible result. A vertical scale factor, related to uncorrected image height divided by corrected image height, of the resized image on the display device before projection is reduced from the left side, 302, of the resized image, to the right side, 304. The horizontal scale factor, related to uncorrected image width divided by corrected image width, is also reduced from the left side of the image to the right side of the correction image. The resulting projected corrected image 310 on a screen 306 misaligned with a projector 100 is illustrated on FIG. 3B, which appears to a viewer as a rectangular and undistorted image. The original input image would have been projected as the quadrilateral 312, the outline of which is illustrated on FIG. 3B with dotted lines.

The horizontal and vertical scale factors, which express the relationships between input width and height to output width and height, vary linearly from input pixel to input pixel and from input line to input line. Specifically, scale factors are the ratio of an incremental change in input position, such as on a display device, to an incremental change in output position, such as on a screen. A horizontal scale factor is measured horizontally, and a vertical scale factor is measured vertically.

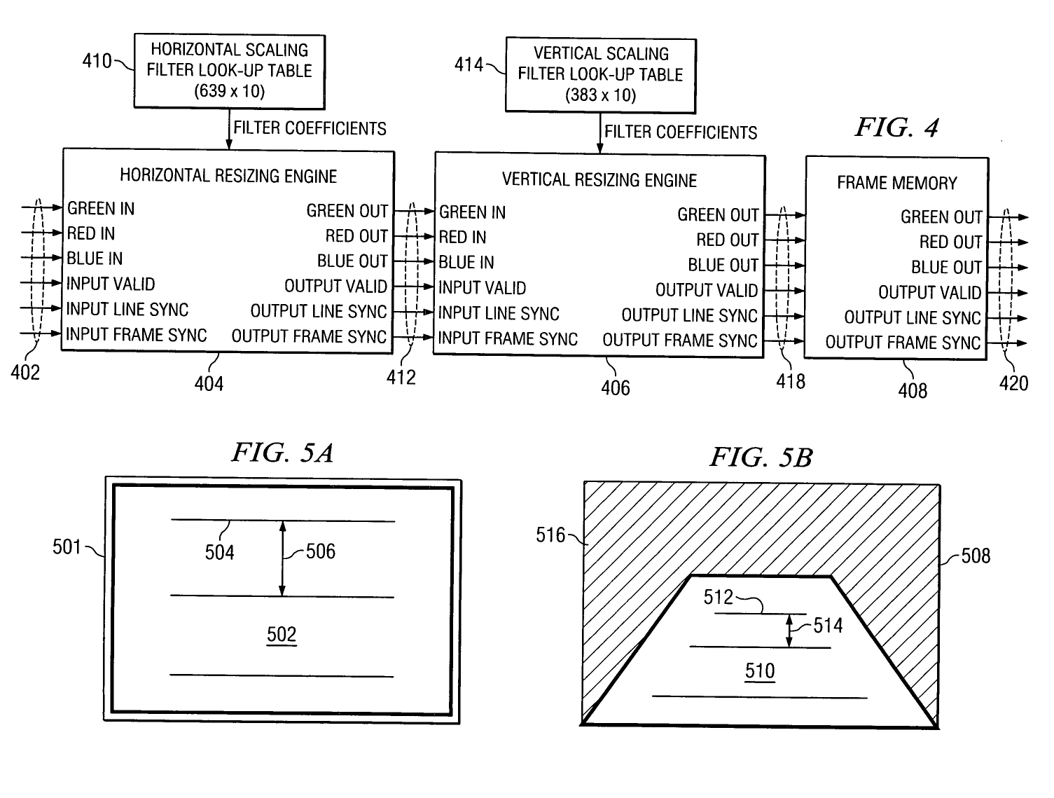

FIG. 4 illustrates the general structure and process flow of the separable, position-based scaling operation that can be utilized to minimize hardware or software requirements and ultimately cost of an integrated circuit device to perform image resizing such as an ASIC. In alternative embodiments, the resizing engines of the preferred embodiments can be realized in a general or special purpose processor running appropriate routines. A digital color image in the form of a raster scan 402 is sequentially presented at periodic clock pulses to the horizontal resizing engine 404. The horizontal resizing engine uses filter coefficients for a polyphase decimation filter stored in the horizontal scaling filter look-up table 410 to sequentially produce a horizontally corrected raster scan 412 for the vertical resizing engine 406. The vertical resizing engine then uses filter coefficients for a second polyphase decimation filter stored in the vertical scaling filter look-up table 414 to sequentially produce a raster scan 418 that is both horizontally and vertically corrected. The vertical resizing engine stores the result in a frame memory 408, which can be read to produce a sequential raster scan 420 for a display device (not shown).

The keystone correction calculation for a projected image with two axes of projection misalignment is an extensive calculation dependent on a number of input variables that describe the misaligned geometry of the projector and the screen. To explain the overall correction process, a simplified example is described first, followed by a description of the complete calculation.

Turning to FIGS. 5A and 5B, illustrated is an exemplary mapping of pixels, using a horizontal keystone resizing engine of the present invention, from an input image such as the uncorrected input image 502 illustrated in FIG. 5A to form a resized image 510 on a digital micromirror device or any other display device, such as illustrated in FIG. 5B. The example illustrated for explanatory purposes of the operation of the horizontal keystone-resizing engine is a simple example including only a misalignment of the projector along a vertical axis. In the more general case two components of misalignment of a projector with a screen, such as projection errors in both pitch and yaw, are corrected. A horizontal keystone-resizing engine is the first of the two separable steps of horizontal and vertical resizing in generating a corrected image on a viewable screen. The image correction process is configured in the present invention with these separate engines to simplify the overall computation, and to reduce the resulting size of an integrated circuit that may embody the process, or the complexity or execution time of software that may perform the computation. Although the steps of keystone correction are separable, vertical image alignment parameters are provided to the horizontal resizing engine so that it can anticipate the further horizontal corrections that will be made by the vertical resizing engine, and thereby enable the horizontal resizing engine to correctly perform its initial horizontal correction calculation.

A color image is generally formed with three color components such as red, green, and blue components, i.e., “RGB components.” The image correction process will be described for only one image component because the corrections for the other components are similar. Other image representations such as a representation based on luminance and chrominance image components or a black-and-white representation are well within the broad scope of the present invention.

The raster-scanned rows in commonly used non-interleaved imaging standards such as television imaging standards are sequentially scanned pixel-by-pixel from left to right, and from top to bottom. Other image standards employ interleaved scanning of rows. In one commonly used high-definition television standard, there are 1080 rows and 1920 pixels in each row. In the United States, such an image is scanned 60 times per second to provide synchronization with the ac power-line frequency. The uncorrected input image, 502 illustrated in FIG. 5A would ordinarily substantially fill the image space of a display device such as a digital micromirror device. The resized image, 510 illustrated in FIG. 5B, only occupies a portion of the image space of the display device, and thus requires a “decimation” or pixel removal process for its creation. Remaining portions of the resized image, such as the area 516, are blackened so that they are not visible to a viewer when displayed. The even spacing between lines such as represented by line spacing 506 is changed linearly across the image, resulting, for example, in the contracted line spacing such as line spacing 514 as illustrated on FIG. 5B.

The resized image is constructed from rows of pixels, such as the sample image line 504 in the uncorrected input image, to produce the sample image line 512 in the resized image. The rows in an undistorted image and the pixels within these rows are uniformly spaced to conform to the ordinary design of display devices such as DMD™s. However, the pixels in the uncorrected input image are mapped into unevenly spaced locations in the resized image. Nonetheless, the individual lines and pixels in the resized image are also necessarily evenly spaced, again to conform to the ordinary design of display devices.

To reduce the numerical computation in the process that maps the original uncorrected input image into an image corrected for keystoning, a simplification is made in the calculation by using image-scaling factors that preferably change only linearly across the image. This preferred simplification does not result in any noticeable loss of displayed image quality. Before the image can be corrected, the location of the four corners of the resized image on the display device and how a scaling factor changes across the image must be supplied to the correction process from a separate source. The parameters used to describe the geometrical transformation into a resized image are described in the co-pending patent application with attorney docket number TI-39900 as previously referenced and incorporated herein.

The horizontal scaling factor can change from pixel to pixel as determined from the input parameters to the process. The decimation process preferably can only produce fewer pixels in the resized image, resulting in a smaller resized image on the digital micromirror device or other display device; if image enlargement (using interpolation) were performed, portions of the resulting resized image might fall outside the physical boundaries of the display device and not be displayed. Image enlargement or reduction on the projection screen, if necessary, can be performed by relatively simple optical means such as by a zoom lens. The keystone correction process preferably is not structured to correct a rotational misalignment of the projector, which can usually be easily corrected by a simple mechanical rotation of the projector itself.

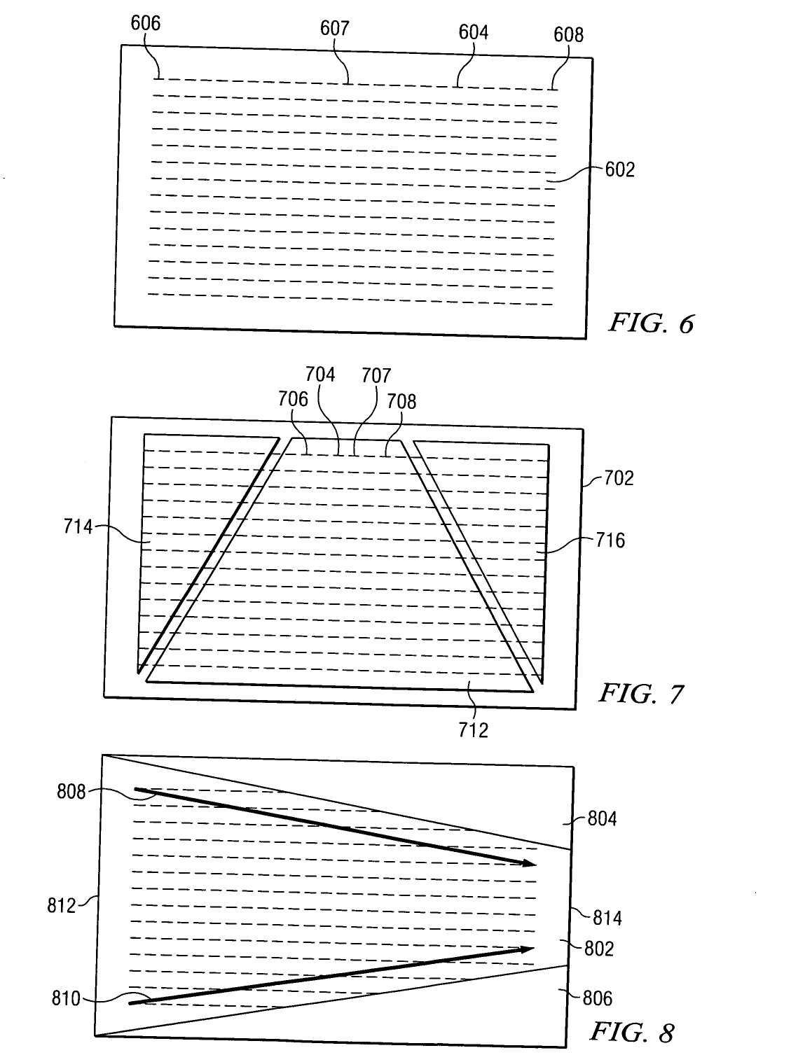

Turning now to FIG. 6, illustrated is a raster-scanned input image 602 to be resized by the horizontal image-resizing engine for the single-axis error example presently being discussed. This engine, which performs the first step in the image correction process, maps corrected pixels line-by-line from the uncorrected input image to the resized image. For example, the three pixels 606, 607, and 608 illustrated on FIG. 6, representing pixels at the left end, middle, and right end of the first line 604 of the uncorrected input image, are mapped into the pixels 706, 707, and 708 in the first line of the resized image illustrated on FIG. 7. Since pixels can be dropped by this mapping process, i.e., pixels are “decimated” but not “interpolated” because a line of pixels preferably can only be shortened to remain on the display device, and since there is a change in pixel geometry in the resized image due to dropping pixels, a filtering process is required to prevent image “aliasing”. Image aliasing can degrade image quality due to noise or excessive bandwidth of the original image signal represented by the pixels. Pixels cannot just be “thrown away” to produce a shorter line without degrading image quality. Thus, a digital low-pass filter is included in the image correction process to reduce the bandwidth of the video signal in the process of removing pixels so that the bandwidth of the corrected signal can be appropriately matched to the new image-sampling rate. The bandwidth of this filter, i.e., its low-pass cut-off frequency, is fixed, preferably at π/128, to eliminate the need for a more complex, tunable filter.

The resulting resized image on the display device 702 as illustrated on FIG. 7 includes blackened areas 714 and 716 that replace areas of the image on the display devise that were originally occupied by portions of the uncorrected input image.

A polyphase decimation filter is used for pixel low-pass filtering during the mapping process. The horizontal resizing engine preferably uses a 639-tap filter configured with 639 coefficients, each preferably with 10 bits of precision to preserve image quality. Filters with a different number of taps and different coefficient precision are well within the broad scope of the present invention. The preferred number 639 results from using five operative filter coefficients per pixel times a fixed interpolation factor for the filter of 128, which is inversely proportional to the fixed filter bandwidth as described above. The number “1” is then subtracted from this product to produce an odd number which is required to simplify the filter implementation. Other numbers of operative filter coefficients can alternatively be used, for example, three or seven. The number 128 is 2 raised to an integer power, which is a further constraint for a simple filter implementation. The 639 filter coefficients are preferably stored in a look-up table. The filter coefficients are readily generated from a function of the form (sin(ω_{c}n))/(πn) where “ω_{c}” is the filter cut-off frequency in radians per second, and “n” is the coefficient number in the sequence of filter coefficients. Preferably, this function is multiplied by a windowing function to remove the Gibbs phenomenon at the filter cut-off frequency, as is well understood in the art. Of course, other filter design methods can be used, for example, the remez exchange algorithm, least squares, etc.

Conceptually, each pixel in an image that passes through the filter requires 639 multiplications to produce a corrected pixel, but the polyphase decimation filters preferably used herein can be structured to use only five multiplications and four additions per pixel in the horizontal resizing engine, and only three multiplications and two additions per pixel in the vertical resizing engine that will be described hereinbelow. The general case of an image requiring correction of two axes of misalignment preferably requires a different set of filter coefficients for each pixel, which vary in both the horizontal and vertical dimensions across an image. Nonetheless, the processing of a high-definition television picture with 1920 pixels per line, 1080 lines per image, and 60 images per second is challenging but practical with current silicon technology using the horizontal and vertical resizing engines of the present invention, illustrating the importance of the savings in computation when using the present invention. The general design of polyphase filters is described in R. A. Haddad, et al., “Digital Signal Processing,” W. H. Freeman and Co., 1991, pp. 202-232, which is hereby referenced and incorporated herein.

The horizontal resizing engine can change the number of pixels in a line of the image and the horizontal position of the filtered pixels. Control parameters adjust the centering of each corrected line to control image shear, i.e., the variable horizontal displacement of a line across the vertical dimension of the image. No discernible picture quantization results when locating the filtered pixels because only the bandwidth of the decimation filter is quantized, which has little visible effect. The control computation for the location of the filtered pixels can be performed with arbitrary accuracy, and is quantized only to the finely placed, integer positions of the pixels. A line which is formed with 1920 pixels can thus have one pixel smoothly removed from the resized image by the decimation process without producing visible stair-stepped or irregular effects. In addition, the horizontal resizing engine need only operate on one line at a time, and thus it only requires a relatively simple “line memory” for its operation.

Next, an overview of the vertical keystone resizing engine of the present invention is given, which is the second step in the image correction process. Again, a simple example is used for explanatory purposes wherein only a misalignment of the projector along a horizontal axis has been made. Turning now to FIG. 8, a mapping of pixels is illustrated from an uncorrected input image, such as the image on FIG. 6, to form a resized image that is corrected for keystoning for projection from a digital memory device or other display device such as 802. On the left edge 812 of this exemplary image, no decimation is required, and the image fills the vertical dimension of the display device with a scale factor of unity. On the right edge 814 of the image, a decimation process is required to reduce the bandwidth of the signal along the vertical dimension by about 60% for the present example, since the image appears to fill only a portion of the vertical dimension of the display device and therefore inherently loses about 40% of the original image information due to the reduced number of pixels actively used for its display. The required image information reduction is preferably linear across the horizontal dimension of the image. Decimation again requires filtering to reduce the bandwidth, which again uses a polyphase decimation filter to prevent aliasing with a fixed bandwidth, preferably π/128, eliminating the need for a more complex, tunable filter in the design. The vertical decimation filter preferably uses 383 filter coefficients, which results from the product of three operative filter coefficients times 128, minus one. Alternatively, fewer or more operative filter coefficients can be used with the present invention, such as 1 or 5. Each pixel in the corrected image again preferably requires a different set of operative filter coefficients to accommodate the varying factor of decimation across the image.

The corrected pixels in the horizontal engine described above are computed in a serial manner, one clock cycle at a time, following the typical left-to-right and top-to-bottom raster scanning process for the image, and thus only requires memory for one line of the image for the horizontal correction engine. For the vertical correction engine, a frame memory is required because the vertical relocation of the filtered pixels generally results in positioning a pixel on a different line from its original location. Thus, a line of pixels which was originally horizontal in the uncorrected image can be written as a diagonal line in the corrected image as indicated by the diagonal lines represented by the arrows 808 and 810 on FIG. 8. The vertical resizing engine does not change the horizontal location of the pixels, which was done by the horizontal resizing engine. Logic is included in both engines to prevent mapping multiple pixels to the same point in the corrected image during decimation and to discard excess pixels in an orderly manner. Control computation for the location of the vertically filtered pixels again can be performed with arbitrary accuracy, with quantization only to the finely placed, integer positions of the pixels on the display device. No discernible picture quantization results from relocating the vertically corrected pixels because only the bandwidth of the decimation filter is quantized, which has no perceptible visible effect.

Frame memory supporting the vertical resizing engine is operated in a “burst” read and write mode to achieve the necessary efficiency to support the high data-rate required by the vertical resizing engine. The vertical resizing engine is organized to read or write a number of words to or from frame memory at one time, rather than one word at a time, which is less efficient for the frame memory.

Areas of the image on the display device not occupied by the resized image, such as the areas 804 and 806 illustrated on FIG. 8, are filled in black so that they are not visible when displayed. When the display memory is originally written, such as when the display device is turned on, the entire frame memory is written black. The entire frame memory is also written black whenever an adjustment is made to the keystone alignment of a displayed picture such as when an operator manually depresses keystone alignment control buttons. A manual data input such as this is typically used to adjust the parameters supplied to the horizontal and vertical image resizing engines, but other alignment data input processes such as an automatic process configured with a CCD camera observing the displayed image is well within the broad scope of the present invention.

The scaling operation performed by both the horizontal and vertical resizing engines can be further described in terms of classical sample-rate conversion theory as follows.

Increasing the sample rate by an integer factor, L, is accomplished by expansion followed by low-pass filtering. Expansion consists of entering L-1 zeros between samples of the input sequence. To construct the final output sequence and to prevent aliasing, the expanded sequence is passed through a low-pass filter with cutoff frequency π/L and gain L.

Reducing the sample rate by an integer factor, M, is achieved by low-pass filtering followed by compression. In order to prevent aliasing, the cutoff frequency of the low-pass filter must be set to π/M or less. Subsequently, compression is achieved by sampling the filtered sequence, x[n], with period M. This produces the output sequence x[nM].

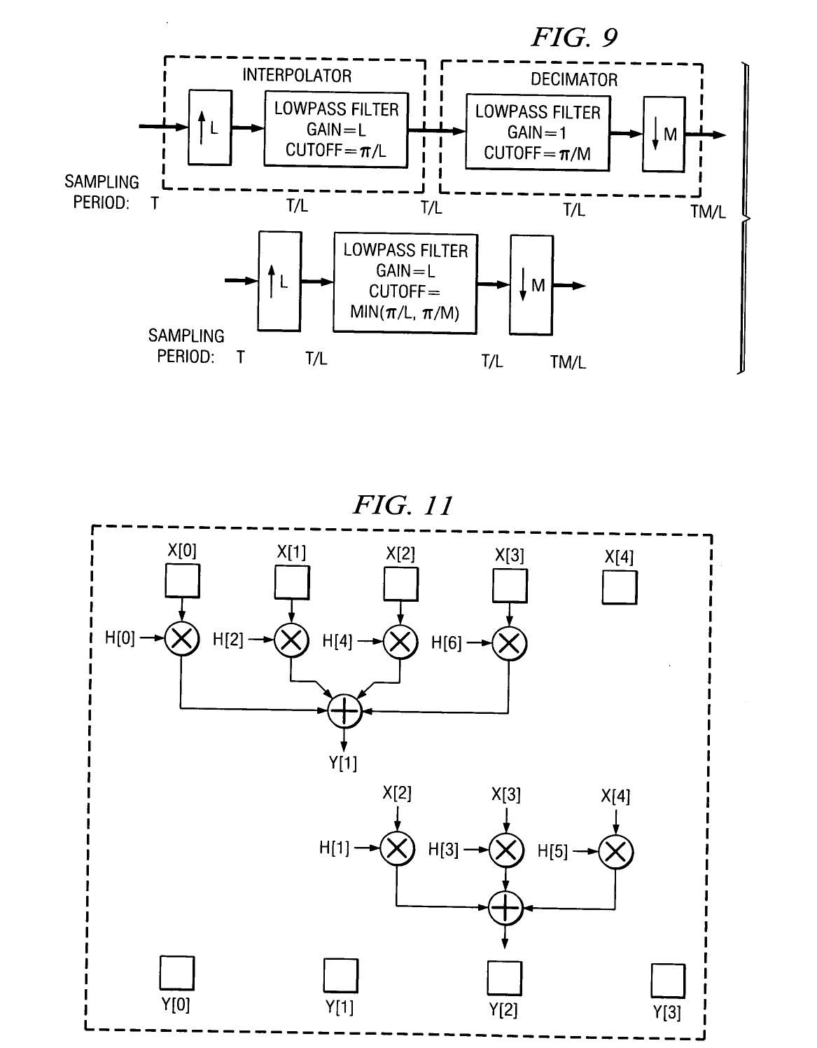

These two operations, interpolation and decimation, may be combined to change the sample rate by a non-integer factor. FIG. 9 illustrates this combination.

By choosing L and M appropriately, any output resolution can be produced for a given input resolution. If M is greater than L the resolution decreases, and if M is less than L, the opposite is true. Additionally, the output resolution may vary locally by altering M and L with input position. Only decimation (M≧L) preferably is required, since the keystone corrected image is preferably smaller in size than the original image as shown in the lower portion of FIG. 5.

To eliminate the need for a tunable low-pass filter, the minimum of π/L and π/M, the cutoff frequency of the low-pass filter, is fixed. In particular, the maximum of L and M is preferably limited to 128. Since only decimation is preferably used, this means that M is preferably set to 128 and L equals M times a scaling factor. By setting the cutoff frequency to a reasonably small value such as π/128, approximation error is limited to a non-perceptible level.

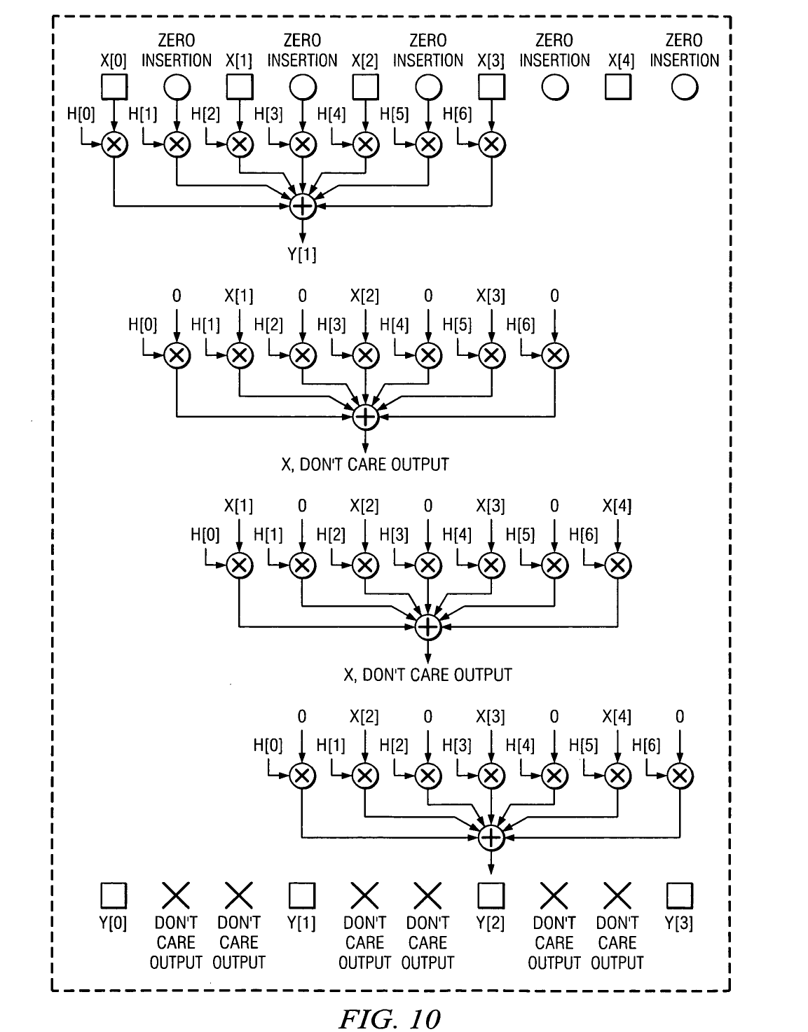

The properties of expansion and compression on either side of the low-pass filter can be exploited to reduce the complexity of the finite impulse response (FIR) filter implementation. It should be noted that only every L^{th} input sample into the low-pass filter is nonzero. Consequently, for a given input sample, only a limited number of filter taps contribute to the final filtered result. Additionally, compression eliminates several filtered results; only every M^{th} output sample is retained. An FIR filter implementation that exploits these properties is referred to as a polyphase filter. FIGS. 10 and 11 illustrate a comparison between a non-polyphase filter and a polyphase filter. FIG. 10 illustrates a non-polyphase filter implementation with an interpolation factor L=2, a decimation factor M=3, and a scale factor of 0.67. This filter results in 7 multiplies per filtered output sample. FIG. 11 illustrates a polyphase filter implementation with the same interpolation factor L=2, decimation factor M=3, and scale factor of 0.67. This polyphase filter results in only 4 multiplies per filtered output sample. Sampling rate alterations and the use of polyphase filters are further described in R. A. Haddad, “Digital Signal Processing,” W. H. Freeman and Co., 1991, pp. 202-322, which is hereby referenced and incorporated herein.

The number of multiplies per output is reduced using a polyphase filter implementation. The inserted zeros in the expanded sequence are ignored, and a decimation filter is used on the original input sequence. Each decimation filter is referred to as a “phase” within the original FIR filter, hence the name “polyphase filter”. Two phases are illustrated in FIG. 11, the phase (h[0], h[2], h[4], h[6]) and the phase (h[1], h[3], h[5]).

The polyphase filter implementation not only reduces the amount of multiplies per output but also decreases the filter clock speed. This is due to the fact that the polyphase filter produces only retained output values. The non-polyphase filter operates on the expanded input and output pixel grids. If the input image were from an image displayed on an SVGA display with a source providing a 60 Hz refresh rate, the input pixel clock would be 40 MHz, and the non-polyphase filter would operate at 2*40 MHz=80 MHz. Comparatively, the polyphase filter would operate at the desired output rate which is 0.75 times the input rate, which is equal to 0.75*40 MHz=30 MHz.

Even though a polyphase filter does not explicitly perform the expansion and compression functions, the relative pixel positions between the expanded input and output pixel grids must be known. This information is needed to determine when to produce an output value and the corresponding filter phase required to generate this output value. This position information is derived from four parameters: horizontal scale factor, horizontal alignment point, vertical scale factor, and vertical alignment point. The alignment points describe the amount of shear in the output image.

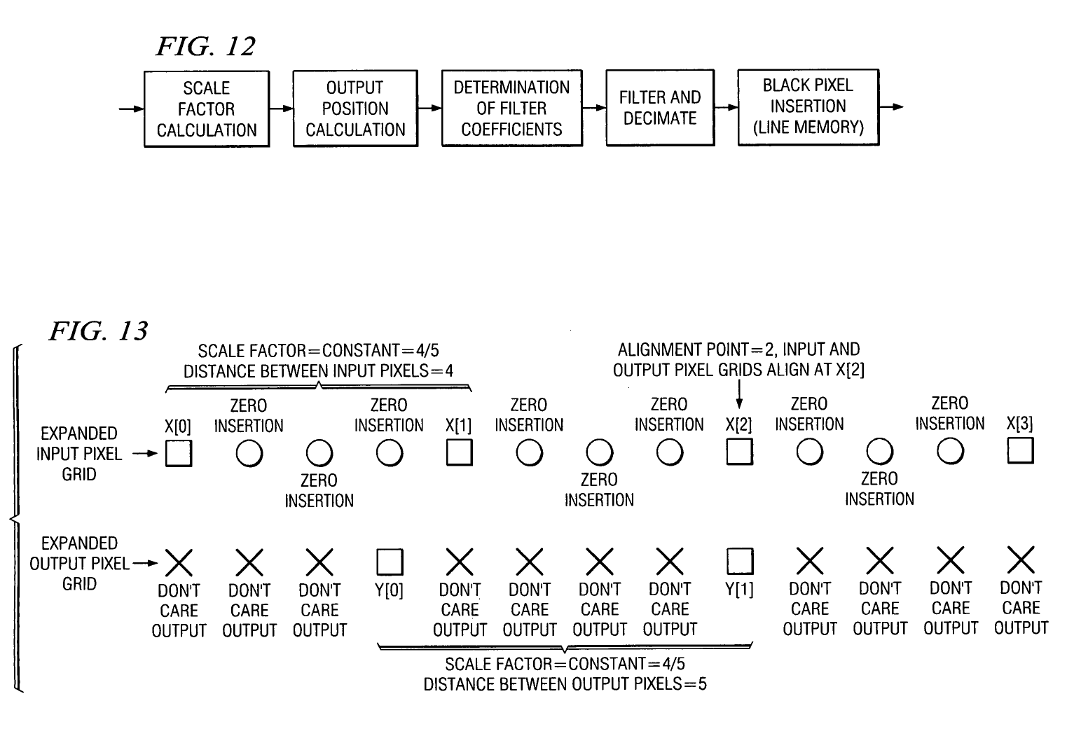

The order of processing for the horizontal resizing engine is shown in FIG. 12. The horizontal scale factor can vary linearly from pixel to pixel and from line to line. Thus, a linear equation relates vertical and horizontal input position to horizontal scale factor. The vertical input position must be adjusted, however, to accommodate resizing changes that will be made later in the processing path by the vertical resizing engine. Thus, the horizontal resizing engine must operate on the vertically resized position information to achieve the final, desired result.

The following equations, which follow a general high-level programming language syntax such as MatLab®, elaborate on these relationships. The “=” sign in these and following equations designates the operation of “assignment” of a known numerical input quantity to the variable preceding the “=” sign and can be read as “be set to”. If the quantity preceding the “=” sign is the result of computation herein described, then the “=” sign can be taken to identify the computed output variable. The phrase “Let x=” either means “assignment,” i.e., that the variable x is set to the value indicated to the right, which is an input parameter supplied to the process, or else the variable x is the result of computation by the statement to the right. The phrase “Let x=” can also be used to describe a variable. The double equal sign “==” is read as numerical equality of the quantities preceding and following this sign. The function “round” means “find the nearest integer” and the function “absolute” means “take the absolute value.” The function “truncate” means “drop the fractional part of the number”. The input parameters for the resizing engines are further described in co-pending application “Three-Dimensional Keystone Correction Projection System and Method,” with attorney docket number TI-39900.

Position Input Parameters for the Horizontal and Vertical Resizing Engines

Let x=horizontal input position of the current uncorrected pixel of the current line for the current input frame

Let xn=total input width. For example, for an image with 600 horizontal lines, each with 800 pixels, xn=800.

Let y=vertical input position of the current uncorrected pixel of the current line for the current input frame

Let yn=total input height. For example, for an image with 600 horizontal lines, each with 800 pixels, yn=600.

Vertical Resizing Engine Input Parameters for the Horizontal and Vertical Resizing Engines

Let vta=average vertical scale factor for the top line of the input image. The average can be computed from the scale factors at the left and right ends of the top line, and assuming linear variation between the ends.
Let dvta=change in vta from the top line of the uncorrected input image to the bottom line of the input image. Again, linear variation can be assumed from the top to the bottom of the image.
Let ynoa=average vertical output resolution. This parameter may be calculated by averaging the height of the left and right edges of the corrected image.
   Vertical Resizing Engine Output Parameters
Let va=average vertical scale factor for the current input line y
Let ya=adjusted vertical input position
   Horizontal Resizing Engine Input Parameters
Let hi=horizontal scale factor at position (0,0), upper left-hand corner of input image
Let hdh=change in horizontal scale factor across row zero, top line of input image
Let hdv=change in horizontal scale factor across column zero, left column of input image. In other words, this is the change in the horizontal scale factor across the left edge of the corrected image.
Let hddh=change in hdh from the top line of the input image to the bottom line of the input image
   Horizontal Resizing Engine Output Parameters for the Vertical Resizing Engine
Let hy=horizontal scale factor for current line, column zero
Let hdy=change in horizontal scale factor across the current line
Let h=current horizontal scale factor
   Horizontal Resizing Engine Equations
   va=vta+y/yn*dvta
   ya=y*va
   hy=hi+ya/ynoa*hdv
   hdy=hdh+ya/ynoa*hddh
   h=hy+x/xn*hdy

The horizontal scale factor describes the horizontal distance between input pixels on the expanded input pixel grid and the horizontal distance between output pixels on the expanded output pixel grid. It does not, however, specify the relationship between these two grids. The horizontal alignment point describes where these two grids align. FIG. 13 illustrates the concept of grid alignment for the simple case of a constant scale factor of 4/5, which results in the distance between input pixels being 4, and the distance between output pixels being 5. Note that in actual hardware for the illustration in the figure, the scale factor denominator will be forced to 128. The numerator for this example will therefore be equal to 128*(4/5)=102.

As illustrated on FIG. 13, the horizontal alignment point is defined in reference to the input position. In the case of a sheared image requiring horizontal alignment of the image lines, the alignment point may be outside the bounds of the original image (less than zero or greater than the number of pixels per line). To prevent indeterminate solutions, the horizontal scale factor for pixels lying outside the bounds of the input image is mapped to the average horizontal scale factor for the input line from which they came. Whereas the horizontal scale factor determines the length of a given output line, the horizontal alignment point specifies the position of the output line. A user-defined horizontal offset is also available to shift the outgoing image to the left or to the right by a specified amount. This offset can center the outgoing image correctly.

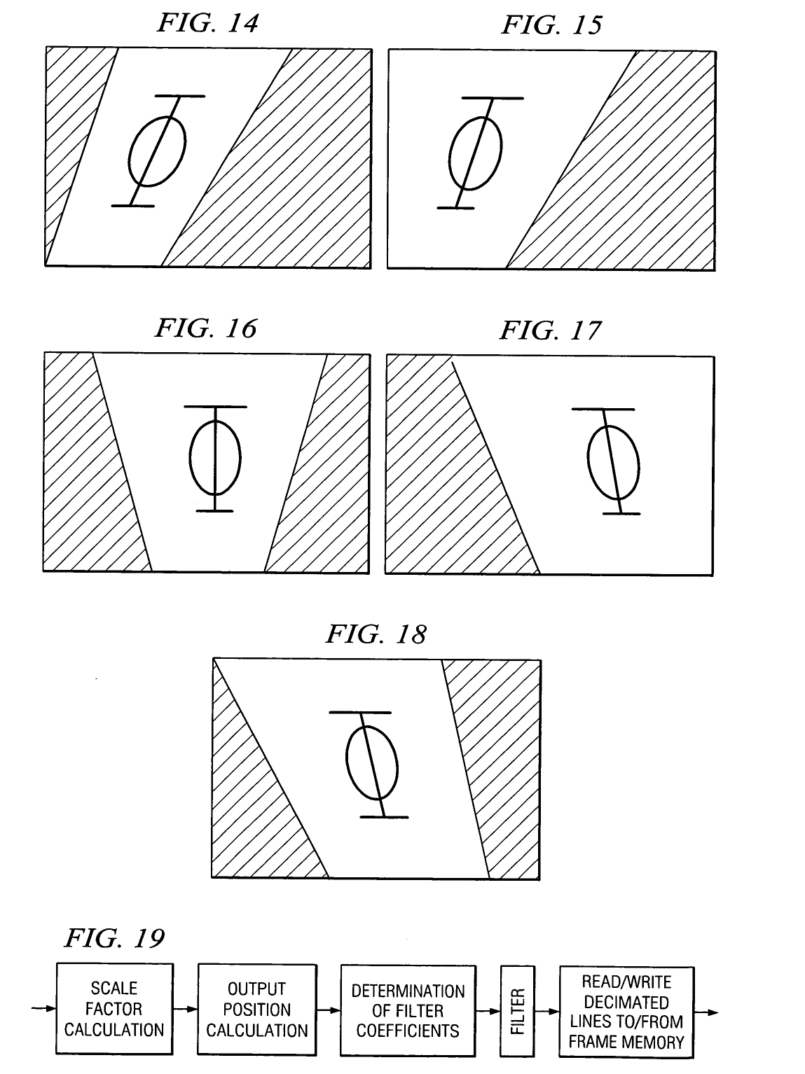

FIGS. 14-18, which show an image of the Greek letter Φ, illustrate the effect of changing only the horizontal alignment point of a corrected line. FIG. 14 illustrates the case of a horizontal alignment point set less than zero. FIG. 15 illustrates the case of a horizontal alignment point set equal to zero. FIG. 16 illustrates the case of a horizontal alignment point set to the midpoint of a line. FIG. 17 illustrates the case of a horizontal alignment point set equal to the number of pixels per line. And FIG. 18 illustrates the case of a horizontal alignment point set greater than the number of pixels per line.

The horizontal alignment point and the horizontal scaling factor are used to determine when to produce an output pixel and to provide the spatial position of this output pixel. It is important to note that the horizontal resizing engine only resizes a given input line. Thus, an output pixel created from input pixels on line 50 will be placed on line 50 of the output image.

Position Input Parameters for the Horizontal Resizing Engine

Let x=horizontal input position of the current uncorrected pixel of the current line for the current input frame

Let xn=total input width as described above

Let y=vertical input position of the current uncorrected pixel of the current line from the current input frame

Let yn=total input height as described above

Horizontal Resizing Engine Input Parameters

Let ah=horizontal alignment point of the current line. A single horizontal alignment point is used for one input frame.
Let hoff=output position horizontal offset (for correct output image placement on the display device) Example?
   Horizontal Resizing Engine Output Parameters to the Vertical Resizing Engine
Let hy=horizontal scale factor for current line, column zero (refer to previous equations)
Let hdy=change in horizontal scale factor across the current line (refer to previous equations)
Let h=current horizontal scale factor of the current pixel (refer to previous equations)
Let hs=sum of horizontal scale factors from current pixel to the horizontal alignment point
Let havg=average horizontal scale factor for the current input line y
Let ha=horizontal scale factor at the horizontal alignment point
Let ov=output valid flag (when equal to 1 the current input pixel produces an output pixel)
Let op(x,y)=horizontal output position for input position (x,y). Identifies x,y coordinates of corrected pixel
Let opr(x,y)=op(x,y) rounded to the nearest integer (used for output pixel placement when ov=1)
Let operr(x,y)=absolute difference between op and opr
Let xoff=horizontal input position offset

Horizontal Resizing Engine Equations

```
for y = 0 to yn
  for xoff = 0 to xn
    for x = xoff−1 to xoff+1
      havg = hy + hdy/2
      if (ah < 0)
        ha = havg
        hs = ha * −1 * ah + x * (hy + h)/2
      else if (ah <= xn)
        ha = hy + ah/xn * hdy
        hs = absolute(x − ah) * (ha + h)/2
      else
        ha = havg
        hs = ha * (ah − xn) + (xn − x) * (h + hdy/2)
      end
      if (x <= ah)
        op(x,y) = ah − hs + hoff
      else
        op(x,y) = ah + hs + hoff
      end
      opr(x,y) = round(op(x,y))
      operr(x,y) = absolute (opr(x,y) − op(x,y))
    end
    if (opr(xoff−1,y) == opr(xoff,y)) AND (opr(xoff+1,y) == opr(xoff,y))
      if (operr(xoff,y) < operr(xoff−1,y)) AND
      (operr(xoff,y) <= operr(xoff+1,y))
        ov = 1
      else
        ov = 0
      end
    else if (opr(xoff−1,y) == opr(xoff,y))
      if (operr(xoff,y) < operr(xoff−1,y))
        ov = 1
      else
        ov = 0
      end
    else if (opr(xoff+1,y) == opr(xoff,y))
      if (operr(xoff,y) <= operr(xoff+1,y))
        ov = 1
      else
        ov = 0
      end
    else
      ov = 1
    end
  end
```

When an output pixel is required (ov is equal to one), the input must be filtered with the correct filter phase. A 639-tap anti-aliasing filter is stored in RAM for coefficient generation. The number of taps per phase is held constant. In particular, there are five taps per phase used by the horizontal resizing engine. By holding the number of taps per phase constant, the memory and logic requirements become independent of the scale factor. In other words, for any given scale factor, only four registers and five multiplies are needed to produce an output pixel. The equations below describe how the filter coefficients are generated and how the input is filtered.

Position Input Parameters to the Horizontal Resizing Engine

Let x=current horizontal input position as described above
Let y=current vertical input position as described above
   Horizontal Resizing Engine Input Parameters to the Horizontal Resizing Engine
Let ah=horizontal alignment point as described above
Let hoff=output position horizontal offset (for correct output image placement on the display device) as described above
   Horizontal Resizing Engine Output Parameters to the Vertical Resizing Engine
Let hy=horizontal scale factor for current line, column zero (refer to previous equations)
Let hdy=change in horizontal scale factor across the current line (refer to previous equations)
Let h=current horizontal scale factor (refer to previous equations)
Let op(x,y)=horizontal output position for input position (x,y) (refer to previous equation)
Let opt(x,y)=op(x,y) truncated to the nearest integer
Let opr(x,y)=op(x,y) rounded to the nearest integer (refer to previous equation)
Let operr(x,y)=absolute difference between op and opr (refer to previous equation)
Let td=distance between filter taps
Let cto=center tap offset
Let t1=tap 1 location for current phase
Let t2=tap 2 location for current phase
Let t3=tap 3 location (center tap) for current phase
Let t4=tap 4 location for current phase
Let t5=tap 5 location for current phase
Let c1=tap 1 coefficient
Let c2=tap 2 coefficient
Let c3=tap 3 coefficient
Let c4=tap 4 coefficient
Let c5=tap 5 coefficient
Let hlut[ ]=horizontal anti-aliasing filter look-up table (LUT)
Let n=normalization value for current filter phase (sum of coefficients)
Let o=output pixel value, for example, pixel intensity, 0-255.

Horizontal Resizing Engine Equations

```
td = round(128 * h)
cto = round(128 * operr(x,y))
opt = truncate(op(x,y))
if ((opr(x,y) − hoff) ≦ ah)
  if (opt(x,y) == op(x,y))
    t3 = 319 − cto
  else
    t3 = 319 + cto
  end
else
  if (opt(x,y) == op(x,y))
    t3 = 319 + cto
  else
    t3 = 319 − cto
  end
end
t1 = t3 − 2*td
t2 = t3 − td
t4 = t3 + td
t5 = t3 + 2*td
c1 = hlut[t1]
c2 = hlut[t2]
c3 = hlut[t3]
c4 = hlut[t4]
c5 = hlut[t5]
n = c1 + c2 + c3 + c4 + c5
o = ((x−2,y) * c1 + (x−1,y) * c2 + (x,y) * c3 + (x+1,y) *
c4 + (x+2,y) * c5)/n
```

The output from the horizontal resizing engine is sent through a line memory for black pixel insertion. Outgoing pixels are spread across an entire line time. For example, the first input pixel of a particular line could produce an output pixel at column position fifty. Hence, fifty black pixels must be inserted into the outgoing data stream before this first output pixel. The line memory stores all the outgoing pixels for the current line and reads outgoing data from the previous line. Moreover, it holds the first read until all left-side black pixels have been inserted into the outgoing data stream. Likewise, black pixels are inserted on the right-side of the image if the last outgoing pixel position is less than the incoming line length. The output of this black pixel insertion logic is sent to the vertical resizing engine. The order of processing for the vertical resizing engine is shown in FIG. 19.

Similar to the horizontal scale factor, the vertical scale factor is allowed to vary linearly from pixel to pixel and from line to line as follows.

Position Input Parameters to the Vertical Resizing Engine

Let x=current horizontal input position as described above
Let xn=total input width as described above
Let y=current vertical input position as described above
Let yn=total input height as described above
   Vertical Resizing Engine Input Parameters
Let vi=vertical scale factor at position (0,0), upper left-hand corner of input image
Let vdv=change in vertical scale factor across column zero, left column of input image
Let vdh=change in vertical scale factor across row zero, top line of input image
Let vddv=change in vdv (change in vertical scale factor across a column) from the left edge of the input image to the right edge of the input image
   Vertical Resizing Engine Output Parameters
Let vx=vertical scale factor for current column, row zero
Let vdx=change in vertical scale factor across the current column
Let v=current vertical scale factor
   Vertical Resizing Engine Equations
   vx=vi+x/xn*vdh
   vdx=vdv+x/xn*vddv
   v=vx+y/yn*vdx

A vertical alignment point, referenced with respect to input position, specifies where the expanded input and output grids align vertically. In the case of a sheared image, the alignment point may be outside the bounds of the original image (less than zero or greater than the number of lines per frame). To prevent indeterminate solutions, the vertical scale factor for pixels outside the bounds of the input image are mapped to the average vertical scale factor for the input column from which they came. A user-defined vertical offset is available to shift the outgoing image up or down by a specified amount. This offset will center the outgoing image correctly. The vertical alignment point and the vertical scale factor are used to determine when to produce an output pixel and the spatial position of this output pixel. It is important to note that the vertical resizing engine can only resize a given input column. In other words, an output pixel created from input pixels on column 50 will be placed on column 50 of the output image. The following equations describe these relationships.

Position Input Parameters to the Vertical Resizing Engine

Let x=current horizontal input position as described above
Let xn=total input width as described above
Let y=current vertical input position as described above
Let yn=total input height as described above
   Vertical Resizing Engine Input Parameters
Let av=vertical alignment point
Let voff=output position vertical offset (for correct output image placement on the display device)
   Vertical Resizing Engine Output Parameters
Let vx=vertical scale factor for current column, row zero (refer to previous equations)
Let vdx=change in vertical scale factor across the current column (refer to previous equations)
Let v=current vertical scale factor (refer to previous equations)
Let vs=sum of vertical scale factors from current pixel to the vertical alignment point
Let vavg=average vertical scale factor for the current input column x
Let va=vertical scale factor at the vertical alignment point
Let ov=output valid flag (when equal to 1 the current input pixel produces an output pixel)
Let op(x,y)=vertical output position for input position (x,y)
Let opr(x,y)=op(x,y) rounded to the nearest integer (used for output pixel placement when ov=1)
Let operr(x,y)=absolute difference between op and opr
Let yoff=vertical input position offset

Vertical Resizing Engine Equations

```
for yoff = 0 to yn
  for x = 0 to xn
    for y = yoff−1 to yoff+1
      vavg = vx + vdx/2
      if (av < 0)
        va = vavg
        vs = va * −1 * av + y * (vx + v)/2
      else if (av ≦ yn)
        va = vx + av/yn * vdx
        vs = absolute(x − av) * (va + v)/2
      else
        va = vavg
        vs = va * (av − yn) + (yn − y) * (v + vdx/2)
      end
      if (y ≦ av)
        op(x,y) = av − vs + voff
      else
        op(x,y) = av + vs + voff
      end
      opr(x,y) = round(op(x,y))
      operr(x,y) = absolute (opr(x,y) − op(x,y))
    end
    if (opr(x,yoff−1) == opr(x,yoff)) AND (opr(x,yoff+1) == opr(x,yoff))
      if (operr(x,yoff) < operr(x,yoff−1)) AND
      (operr(x,yoff) ≦ operr(x,yoff+1))
        ov = 1
      else
        ov = 0
      end
    else if (opr(x,yoff−1) == opr(x,yoff))
      if (operr(x,yoff) < operr(x,yoff−1))
        ov = 1
      else
        ov = 0
      end
    else if (opr(x,yoff+1) == opr(x,yoff))
      if (operr(x,yoff) ≦ operr(x,yoff+1))
        ov = 1
      else
        ov = 0
      end
    else
      ov = 1
    end
  end
```

When an output pixel is required (ov is equal to one), the input must be filtered with the correct filter phase. A 383-tap anti-aliasing filter is stored in RAM for coefficient generation. The number of taps per phase is held constant. In particular, there are three taps per phase used by the vertical resizing engine. By holding the number of taps per phase constant, the memory and logic requirements become independent of the scale factor. In other words, for any given scale factor, only two line memories and three multiplies are needed to produce an output pixel. The equations below describe how the filter coefficients are generated and how the input is filtered.

Position Input Parameters to the Vertical Resizing Engine

Let x=current horizontal input position as described above
Let y=current vertical input position as described above
   Vertical Resizing Engine Input Parameters
Let av=vertical alignment point as described above
Let voff=output position vertical offset (for correct output image placement on the display device) as described above
   Vertical Resizing Engine Output Parameters
Let vx=vertical scale factor for current column, row zero (refer to previous equations)
Let vdx=change in vertical scale factor across the current column (refer to previous equations)
Let v=current vertical scale factor (refer to previous equations)
Let op(x,y)=vertical output position for input position (x,y) (refer to previous equations)
Let opr(x,y)=op(x,y) rounded to the nearest integer (refer to previous equations)
Let operr(x,y)=absolute difference between op and opr (refer to previous equations)
Let td=distance between filter taps
Let cto=center tap offset
Let t1=tap 1 location for current phase
Let t2=tap 2 location (center tap) for current phase
Let t3=tap 3 location for current phase
Let c1=tap 1 coefficient
Let c2=tap 2 coefficient
Let c3=tap 3 coefficient
Let vlut[ ]=vertical anti-aliasing filter LUT
Let n=normalization value for current filter phase (sum of coefficients)
Let o=output pixel value

Vertical Resizing Engine Equations

```
td = round(128 * v)
cto = round(128 * operr(x,y))
opt = truncate(op(x,y))
if ((opr(x,y) − voff) ≦ av)
  if (opt(x,y) == op(x,y))
    t2 = 191 − cto
  else
    t2 = 191 + cto
  end
else
  if (opt(x,y) == op(x,y))
    t2 = 191 + cto
  else
    t2 = 191 − cto
  end
end
t1 = t2 − td
t3 = t2 + td
c1 = vlut[t1]
c2 = vlut[t2]
c3 = vlut[t3]
n = c1 + c2 + c3
o = ((x,y−1) * c1 + (x,y) * c2 + (x,y+1) * c3
```

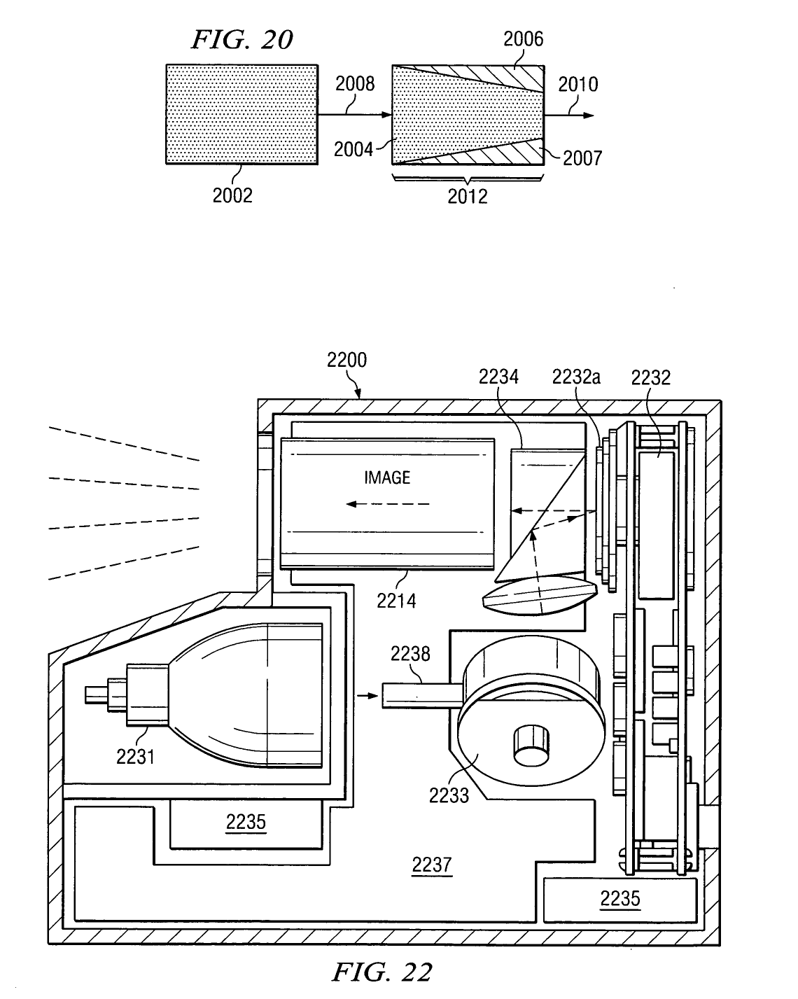

FIG. 20 illustrates graphically the positioning of uncorrected input image data into frame memory using the keystone correction process of the present invention. A frame memory 2012 is used to position the output pixels of the resized image correctly and to place black pixels in the output positions that are not being affected by input pixels. The input data can be associated with a rectangular input image 2002. After decimation filtering and pixel repositioning, the filtered data 2008 is written to frame memory. The decimated and resized image occupies the portion of frame memory illustrated by the memory area 2004, with black pixels written to the undisplayed area of the image such as memory areas 2006 and 2007. Thus, new pixels are only written to decimated locations, i.e., only to memory locations in the memory area 2004. The output data 2010 is read from frame memory in an “orthogonal” manner, i.e., from sequential memory locations. Whenever input image distortion parameters to the vertical resizing engine change, an input frame time is used to write all zeros to the frame memory. In other words, the memory contents are cleared with a black background. When input parameters are stable, output pixels are written to the frame memory according to their column and row positions.

As an example of repositioning the output pixels in a diagonal mapping, Table 1, below, illustrates an uncorrected input image line including pixels (0,0 through (15,0) that is repositioned in a resized image as the pixel sequence (0,0) through (7,0) in the first row of the image and the pixel sequence (8,1) through (15,1) in the second row of the image.

TABLE 1
Example Write for Input Row 0

| Input Position | Output Position |
|---|---|
| (0, 0) | (0, 0) |
| (1, 0) | (1, 0) |
| (2, 0) | (2, 0) |
| (3, 0) | (3, 0) |
| (4, 0) | (4, 0) |
| (5, 0) | (5, 0) |
| (6, 0) | (6, 0) |
| (7, 0) | (7, 0) |
| (8, 0) | (8, 1) |
| (9, 0) | (9, 1) |
| (10, 0) | (10, 1) |
| (11, 0) | (11, 1) |
| (12, 0) | (12, 1) |
| (13, 0) | (13, 1) |
| (14, 0) | (14, 1) |
| (15, 0) | (15, 1) |

For bandwidth efficiency, frame memories have burst read and burst write requirements. In other words, a number of output pixels must be gathered together before they can be written to or read from the frame memory. Additionally, these output pixels must be from the same output line. Since vertical output position varies across an input line, line memories are needed to fulfill this requirement. The number of line memories needed is determined by the following equation.

Input Parameters

Let b=burst write requirement (in terms of number of pixels that must be written as a block to memory in the burst-write mode)
Let a=aspect ratio of the DMD™ or other display device (4/3 or 16/9)
Let d=largest change in vertical scale from the left side of the image to the right side of the image
   Output Parameter
Let n=number of output lines needed to satisfy burst write requirement
   Output Equation
   n=ceiling (d/a*b)

These line memories store the output pixels from the vertical resizing engine. When the vertical output position changes within a burst write for the current line, output data is pulled from the line memories. In other words, the line memories ensure that a burst write contains pixels from the same output line.

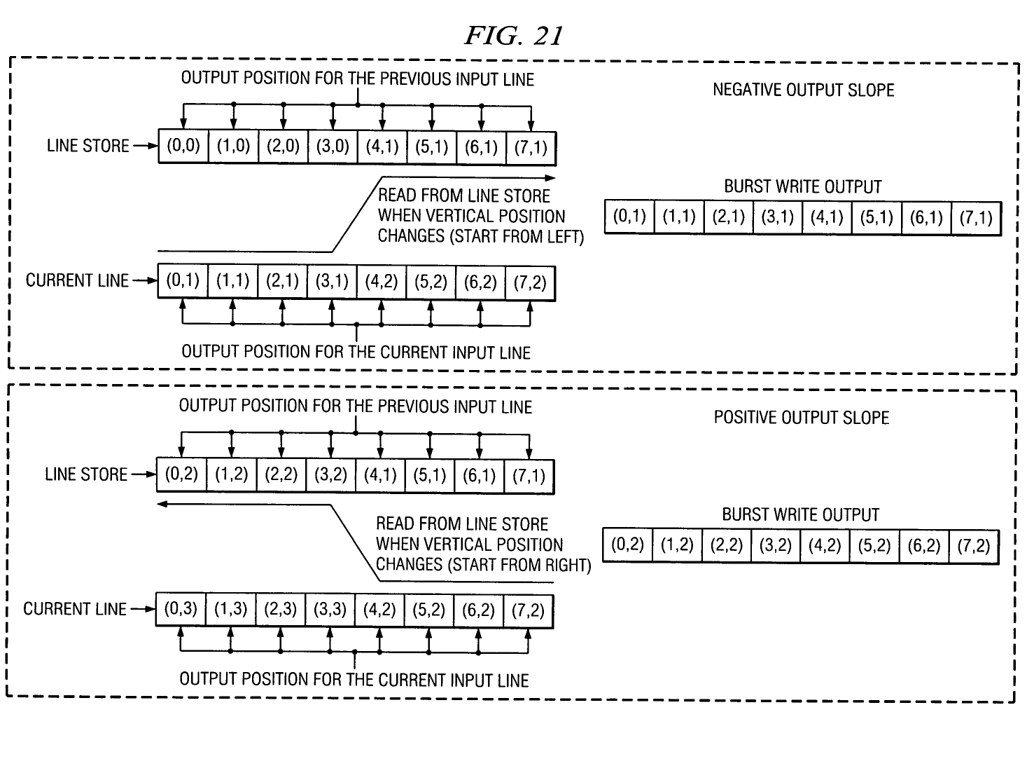

FIG. 21 illustrates how output data is gathered for a burst write of 8 pixels. When the output slope is negative (output lines curve down and to the right), the burst write logic sequentially writes a block of eight pixels from the current line. It scans the vertical output position of each pixel within this block of eight from the leftmost pixel to the rightmost pixel. If the vertical output position changes within this block of 8 pixels, the burst write logic begins to read from the line memory. This process continues (moving up line stores when the vertical position changes) until a block of contiguous output pixels is formed, whereupon they are written to frame memory.

When the output slope is positive (output lines curve up and to the right), the burst write logic writes a block of eight pixels from the current line. It scans the vertical output position of each pixel within this block of eight from the rightmost pixel to the leftmost pixel. If the vertical output position changes within this block of 8 pixels, the burst write logic begins to read from the line memory. This process continues (moving up line stores when the vertical position changes) until a block of contiguous output pixels is formed, whereupon they are written to frame memory.

The decimated data is read from the frame memory in a simple sequential manner. In other words, the data is read out in raster scan order, left to right, and from top to bottom. The input parameters to the equations described above can be determined by characterizing the distorted, projected image. In particular, the throw ratio (the ratio of displayed picture width to the distance of the image from the projector), placement of the digital micromirror device in the optical path, and the projection screen's horizontal and vertical deviation from perpendicular can be used to derive the input parameters described in the computation hereinabove. The translation of optical distortion parameters to two-dimensional keystone correction input parameters is described in the referenced co-pending application with attorney docket number TI-39900.

Turning now to FIG. 22, illustrated is an image projection system 2200 configured with a digital micromirror device and a keystone correction engine according to the present invention. Projection systems configured with digital micromirror devices are well known in the art, and an exemplary system is described in U.S. Pat. No. 6,712,475, entitled “Housing and Internal Layout for Compact SLM-Based Projector,” assigned to Texas Instruments Incorporated, which is referenced and incorporated herein. Projection system 2200 includes a source of illumination provided by a lamp 2231 to illuminate a micromirror display device. A color drum 2233 filters the light from lamp 2231 in the proper sequence of colors, in synchronization with the image data provided to a digital display device such as DMD™ 2232a. Color drum 2233 is a type of color wheel, having its color filters on a cylinder rather than on a flat wheel. Color drum 2233 also has additional optical elements for redirecting light, as shown by the optical path in FIG. 22. A flat color wheel could also be used. Integration optics 2238 shapes the light from the source.

Prism optics 2234 directs light from the color drum 2233 to the DMD™ 2232a, as well as from the DMD™ 2232a to projection lens 2214. The configuration of FIG. 22 has telecentric illumination optics, with prism optics 2234 having a total internal reflection prism that minimizes the size of the projection lens due to keystone correction by offset of the projection lens. However, the same concepts could be applied to non-telecentric designs, but the offset requirements will have an additional effect on the illumination angle required.

Various electrical components, as well as the DMD™ 2232a, are mounted on a printed circuit board 2232. Other components mounted on board 2232 include various memory and control devices.

The non-optical elements of the projection system include one or more fans 2235 and a power supply 2237. The power supply typically provides regulated voltages for use by circuit elements and the micromirror device from an ac wall plug.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that many numerical values of the present invention such as the length of a filter or the number of operational taps may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A digital circuit configured to perform keystone correction for a raster-scanned image, the raster-scanned image comprised of a sequence of horizontal lines of pixels and a set of parameters that describes resizing of the image on a display device, comprising:
a horizontal resizing filter to reduce the number of pixels in a horizontal line of the image using the set of parameters;
a first controller that displaces pixels along a horizontal dimension of the horizontal line using the set of parameters;
a vertical resizing filter to reduce the number of pixels in a vertical line of the image using the set of parameters; and
a second controller that displaces pixels along a vertical dimension of the image using the set of parameters.

2. A digital circuit according to claim 1, wherein the horizontal resizing filter is configured with a first polyphase finite-time impulse response (FIR) filter with constant bandwidth, and the vertical resizing filter is configured with a second polyphase FIR filter with constant bandwidth.

3. A digital circuit according to claim 1, wherein the horizontal resizing filter is operated before the vertical resizing filter engine.

4. A digital circuit according to claim 1, wherein the first controller linearly displaces the pixels along a horizontal dimension of a horizontal line using the set of parameters, and the second controller linearly displaces the pixels along a vertical dimension of the image using the set of parameters.

5. A digital circuit according to claim 1, wherein the second controller writes corrected image data to a frame memory using a burst-write mode.

6. A digital circuit according to claim 2, wherein the first polyphase FIR filter is configured with 639 taps, the second polyphase FIR filter is configured with 383 taps, and the coefficients for the respective filters are stored with 10 bits.

7. A digital circuit according to claim 1, wherein five operable coefficients are used in the horizontal resizing filter, and three operable coefficients are used in the vertical resizing filter.

8. A digital circuit according to claim 1, wherein at least one of the filters is configured with an application-specific integrated circuit (ASIC) device.

9. A digital circuit according to claim 1, wherein the set of parameters that describes the resizing of the image on a display device describes the location of the corners of the resized image on the display device.

10. An image projection system for a raster-scanned image, comprising:
a digital display device;
a lamp to illuminate the digital display device;
a power supply to provide regulated voltage to the digital display device; and
control circuitry configured to perform keystone correction for the raster-scanned image using a set of parameters that describes resizing of the image on the digital display device, including:
a first image resizing engine configured with a horizontal resizing filter to reduce the number of pixels in a horizontal line of the image using the set of parameters;
a first controller that displaces pixels along a horizontal dimension of the horizontal line using the set of parameters;
a second image resizing engine configured with a vertical resizing filter to reduce the number of pixels in a vertical line of the image using the set of parameters; and
a second controller that displaces pixels along a vertical dimension of the image using the set of parameters.

11. The image projection system according to claim 10, wherein the horizontal resizing filter is configured with a first polyphase FIR filter with constant bandwidth, and the vertical resizing filter is configured with a second polyphase FIR filter with constant bandwidth.

12. The image projection system according to claim 10, wherein the first image resizing engine is operated before the second image-resizing engine.

13. The image projection system according to claim 10, wherein the first controller linearly displaces pixels along a horizontal dimension of a horizontal line using the set of parameters, and the second controller linearly displaces pixels along a vertical dimension of the image using the set of parameters.

14. The image projection system according to claim 11, wherein the first polyphase FIR filter is configured with 639 taps, the second polyphase FIR filter is configured with 383 taps, and the coefficients for the respective filters are stored with 10 bits.

15. The image projection system according to claim 10, wherein five operable coefficients are used in the horizontal resizing filter, and three operable coefficients are used in the vertical resizing filter.

16. The image projection system according to claim 10, wherein at least one of the image resizing engines is configured with an ASIC device.

17. The image projection system according to claim 10, wherein the digital display device is configured with deformable mirrors.

18. The image projection system according to claim 10, wherein the control circuitry is operated in a microprocessor.

19. A method of performing keystone correction for a raster-scanned image, the raster-scanned image comprised of a sequence of horizontal lines of pixels and a set of parameters that describes resizing of the image on a display device, comprising:
reducing the number of pixels in a horizontal line of the image with a first image resizing engine configured with a horizontal resizing filter that uses the set of parameters;
displacing pixels along a horizontal dimension of the horizontal line with a first controller that uses the set of parameters;
reducing the number of pixels in a vertical line of the image with a second image resizing engine configured with a vertical resizing filter that uses the set of parameters; and
displacing pixels along a vertical dimension of the image with a second controller that uses the set of parameters.

20. The method according to claim 17, including configuring the horizontal resizing filter with a first polyphase FIR filter with constant bandwidth, and configuring the vertical resizing filter with a second polyphase FIR filter with constant bandwidth.

21. The method according to claim 17, including configuring the horizontal resizing filter with five operable coefficients, and the vertical resizing filter with three operable coefficients.

22. The method according to claim 17, including operating the first image resizing engine before the second image resizing engine.
